(19) United States
(12) Patent Application Publication
(10) Pub. No.: US 2014/0341723 A1
(43) Pub. Date: Nov. 20, 2014

(54) GAS TURBINE VANE INSERT TO CONTROL PARTICULATE DEPOSITION

(71) Applicant: General Electric Company, (US)

(72) Inventor: Corey Bourassa, Niskayuna, NY (US)

(73) Assignee: General Electric Company, Schenectady, NY (US)

(21) Appl. No.: 13/841,366

(22) Filed: Mar. 15, 2013

(51) Int. Cl. F01D 25/12; F01D 5/18

(52) U.S. Cl. CPC F01D 25/12; F01D 5/18; F05D 2260/201; F05D 2260/607; F05D 2230/60
USPC 415/175; 416/97 R; 29/889.21

(57) ABSTRACT

A guide tube assembly in one embodiment includes a guide tube and a collection impingement feature. The guide tube includes an inlet and at least one first impingement opening. The inlet is configured to direct a cooling air flow along the length of the tube in an inlet direction. The at least one impingement feature is configured to direct at least a portion of the cooling air received via the inlet along a first impingement direction. The collection impingement feature receives the at least a portion of the cooling airflow directed in the first impingement direction, collects particulate matter from the cooling airflow upon impingement of the cooling airflow with the collection impingement feature, and directs the at least a portion of the cooling air flow in a second impingement direction toward a surface of the turbine component to be cooled by the cooling air flow.

### BACKGROUND

Gas turbines use air from the atmosphere or surroundings to cool various components or portions of a turbine system. However, gas turbine engines, for example, may operate in environments that contain high levels of air-borne particulate matter. As one example, some geographic regions are in proximity to desert environments, and air-borne particulate matter may include fine grain sand. Such fine sand particulate may be easily ingested into the engine core through an inlet and may subsequently be carried into the cooling air bled off the high pressure core for use in cooling various turbine components. Once the particulate is in the cooling air system, the fine sand particulate may have a tendency or propensity to deposit on surfaces at relatively high temperatures, such as those located in a combustor, components found in the turbine guide vanes aft of the combustor, or the like. Accumulation of particulate over time may block the flow of cooling air and/or may foul small holes and/or films associated with surfaces of the vanes, such as film cooling holes, which may lead to a loss of cooling effectiveness and resulting increased component temperatures, negatively impacting the durability of the component. Fine sand deposits and accumulation may be particularly prevalent when impingement cooling strategies are employed through the use of, for example, an impingement baffle or insert which directs cooling air to impinge in small jets on an internal surface or surfaces of turbine guide vanes adjacent to a hot gas path.

Accumulation of fine particulate matter, such as sand, dust, or the like may develop a thermal barrier between the cooling air and a hot surface or part, thereby increasing the local metal temperature of the surface being cooled relative to the temperature that the surface would be if the particulate had not accumulated. This increase in temperature may reduce component life of the surface or part. Also, the accumulation of particulate from a cooling air flow may block film cooling holes, thereby preventing or reducing film cooling coverage on an external surface of the component, which may also lead to loss of cooling effectiveness, increased component temperature, shortened component life, or the like. Further still, the accumulation of particulate may reduce or damage a film configured to protect a surface from high temperature gas flow, further reducing component life.

Fine sand particulate, for example, may be on the order of between about 1 micron and about 100 microns in diameter. Previous attempts to combat particulate accumulation have provided less than ideal results. For example, use of filters may be impractical due, for example, to difficulties in removing or replacing such filters. Orifices sized to aid in evacuation of particulate have been used with some success to remove larger particulate matter, but such orifices have proven ineffective for fine dust or sand particulate that, for example, may not have sufficient size to provide sufficient inertia for separation from an air flow and removal through such orifices or “dust holes.”

### BRIEF DESCRIPTION

In one embodiment, a guide tube assembly is provided for impingement cooling of a turbine component. The guide tube assembly includes a guide tube and a collection impingement feature. The guide tube has a length, and includes an inlet and at least one first impingement opening. The inlet is disposed proximate to an end of the tube, and is configured to accept a cooling air flow and to direct the cooling air flow along the length of the tube in an inlet direction. The at least one impingement feature is configured to direct at least a portion of the cooling air flow along a first impingement direction. The collection impingement feature is disposed opposite the at least one first impingement opening along the first impingement direction and is positioned to receive the at least a portion of the cooling airflow directed in the first impingement direction. Also, the collection impingement feature is configured to collect particulate matter from the cooling airflow upon impingement of the cooling airflow with the collection impingement feature, and is further configured to direct the at least a portion of the cooling air flow in a second impingement direction toward a surface of the turbine component to be cooled by the cooling air flow.

In another embodiment, an assembly includes a turbine component, a guide tube, and a collection impingement feature. The turbine component includes a surface to be cooled and defines an interior cavity. The guide tube is disposed within the interior cavity of the turbine component. The guide tube has a length and includes an inlet and at least one first impingement opening. The inlet is disposed proximate to an end of the tube, and is configured to accept a cooling air flow and to direct the cooling air flow along the length of the tube in an inlet direction. The at least one first impingement opening is configured to direct at least a portion of the cooling air flow along a first impingement direction. The collection impingement feature is disposed opposite the at least one first impingement opening along the first impingement direction and is positioned to receive the at least a portion of the cooling airflow directed in the first impingement direction. The collection impingement feature is configured to collect particulate matter from the cooling airflow upon impingement of the cooling airflow with the collection impingement feature. Also, the collection impingement feature is further configured to direct the at least a portion of the cooling air flow in a second impingement direction toward the surface of the turbine component to be cooled.

In another embodiment, a method of providing a guide tube assembly for directing a cooling air flow in a first impingement direction configured to remove particulate matter from the cooling air flow is provided. The method includes providing a turbine component comprising a surface to be cooled. The turbine component defines an interior cavity. The surface to be cooled is disposed proximate a leading edge of the turbine component, and the leading edge is configured to direct a high temperature gas flow passing by the leading edge. The method also includes providing a guide tube. The guide tube has a length and includes an inlet and at least one first impingement opening. The inlet is disposed proximate to an end of the tube, and is configured to accept the cooling air flow and to direct the cooling air flow along the length of the tube in an inlet direction. The at least one first impingement opening is configured to direct at least a portion of the cooling air flow along the first impingement direction. Further, the method includes positioning the guide tube disposed within the interior cavity of the turbine component with the at least one first impingement opening oriented toward an aft portion of the turbine component. Also, the method includes providing a collection impingement feature disposed opposite the at least one first impingement opening along the first impingement direction and positioned to receive the at least a portion of the cooling airflow directed in the first impingement direction, the collection impingement feature. The collection impingement feature is configured to collect particulate matter from the cooling airflow upon impingement of the cooling airflow with the collection impingement feature, and to direct the at least a portion of the cooling air flow in a second impingement direction toward the surface of the turbine component to be cooled.

### BRIEF DESCRIPTION OF THE DRAWINGS

FIG. 1 is an overhead schematic view of a guide tube assembly in accordance with various embodiments.

FIG. 2 is a side sectional view of the guide tube assembly of FIG. 1.

FIG. 3 is an enlarged view of an aft portion of the guide tube assembly of FIG. 1.

FIG. 4 illustrates a guide tube exit in accordance with various embodiments.

FIG. 5 illustrates a guide tube exit in accordance with various embodiments.

FIG. 6 illustrates a guide tube exit in accordance with various embodiments.

FIG. 7 illustrates a guide tube exit in accordance with various embodiments.

FIG. 8 is a flowchart of a method for providing a guide tube assembly for directing a cooling air flow in a first impingement (or pre-impingement) direction in accordance with various embodiments.

FIG. 9 is a cross-sectional view of a guide vane including a leading edge cavity and a trailing edge cavity formed in accordance with various embodiments.

FIG. 10 is a perspective view of the guide vane of FIG. 9.

### DETAILED DESCRIPTION

Various embodiments will be better understood when read in conjunction with the appended drawings. To the extent that the figures illustrate diagrams of the functional blocks of various embodiments, the functional blocks are not necessarily indicative of the division between hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Generally, various embodiments provide for improved impingement cooling of a surface of a turbine component. Various embodiments employ a collection surface or other collection feature to remove and/or accumulate dust, sand, or other particulate matter from a cooling flow of air. The collection surface or feature may be configured to collect particulate matter having a size of about 1-100 microns. In some embodiments, particulate matter including particulate as small as about 1 micron or smaller may be accumulated on a collection surface. Thus, accumulation of dust or other particulate matter on a surface to be cooled may be reduced or eliminated. The reduction of the accumulation of dust or other particulates in various embodiments may reduce fouling of surfaces, films, and/or holes of a turbine component to be cooled, thereby improving performance of the turbine component and/or extending the life of the turbine component. The reduction of the accumulation of dust or other particulate matter in various embodiments may reduce the insulating effect of such accumulation, thereby improving the cooling achieved by a cooling air flow directed at a surface to be cooled.

Various embodiments are provided for reducing particulate accumulation on a surface to be cooled, for example a surface of a turbine component such as a guide vane of a nozzle in a gas turbine engine. At least one technical effect of various embodiments is the removal or reduction of particulate matter from a cooling air flow. At least one technical effect of various embodiments provides for the reduction of accumulation of particulate on a surface of interest to be cooled. At least one technical effect of various embodiments is improved cooling of a surface of a turbine component. At least one technical effect of various embodiments is improved performance and/or longer life and/or reduced maintenance expense for a turbine component having a surface cooled with an impinging cooling air flow.

Various embodiments provide for the addition of a pre-impingement guide tube to an existing turbine component design. For example, in some embodiments, an existing turbine component such as a guide vane (or existing design of a vane) as well as an existing impingement baffle of a turbine component (or existing design of a baffle) may be employed with relatively minor geometric modification to accommodate the use of a pre-impingement guide tube (e.g., guide tube 150 discussed below). For example, modifications to the geometry to provide an internal rib geometry may be achieved by making appropriate design changes to a casting mold. The guide tube may be made of the same material, for example, as the impingement baffle, which may provide for reduced cost. According to one embodiment, a guide tube is configured to direct an air flow to a first impingement feature for the removal of particulate matter before the cooling air flow is directed to a surface to be cooled.

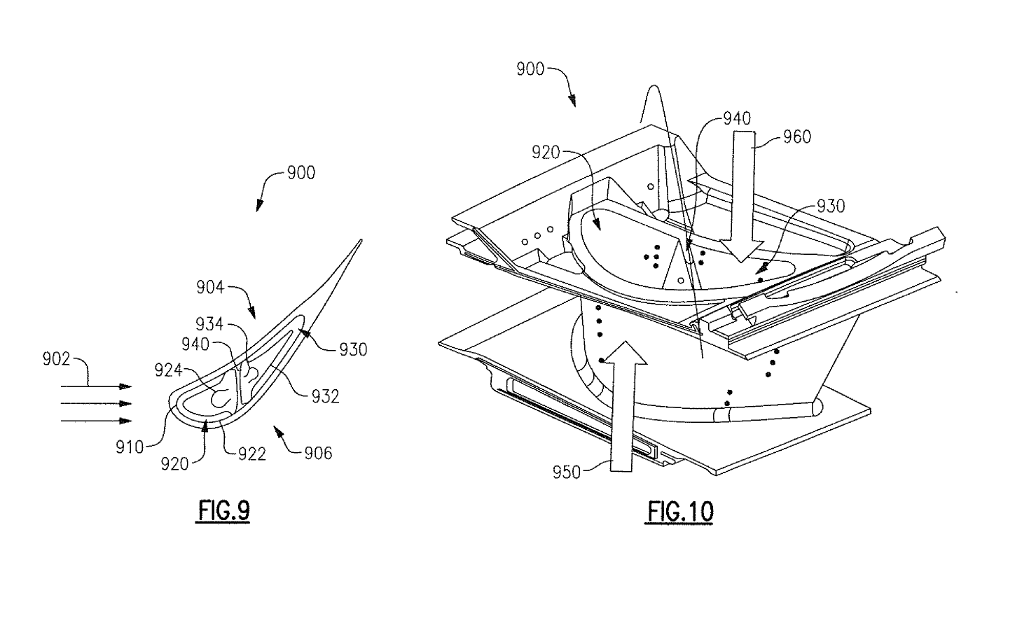

FIG. 1 illustrates a plan view of a turbine component assembly 100, and FIG. 2 illustrates a side sectional view of the turbine component assembly 100. In the illustrated embodiment depicted in FIGS. 1 and 2, the turbine component assembly 100 is configured as a leading edge portion of a static or stationary guide vane 110 of a nozzle interposed between a combustion portion and an exhaust portion of a gas turbine engine. (See also FIGS. 9 and 10 and related discussion describing leading and trailing edge cavities of a nozzle guide vane.) In other embodiments, the turbine component assembly 100 may be configured as a different component than a guide vane of a leading edge cavity of a nozzle. For example, a guide tube assembly 150 in accordance with various embodiments may be used in conjunction with other components of a gas turbine, for example components of a compressor portion, exhaust portion, or nozzle portion, such as splash plates, deflectors, shrouds, other types of blades or vanes, or the like. The turbine component assembly 100 may be closed at the top (e.g., via a metal cap 140 as shown in FIG. 2); however, the turbine component assembly 100 is depicted as open at the top (e.g., with the metal cap 140 removed) for clarity in FIG. 1.

In the illustrated embodiment, the guide vane 110 includes a surface configured as a leading edge 112 of the guide vane 110 configured to be contacted by a high temperature gas flow 102 flowing in an exhaust direction 104 from the combustor portion (not shown) of a gas turbine engine, and to direct the high temperature gas flow 102 to a turbine blade row (not shown) of the gas turbine engine (e.g., past a trailing edge toward the turbine blade row of the gas turbine engine). The guide vane 110 is configured to direct the flow of the high temperature gas flow 102 from the combustor to the turbine blade row to provide work. In the illustrated embodiment, the guide vane 110 is configured as a leading edge portion of a nozzle guide vane, and is configured to direct the high temperature gas flow 102 from the combustor through the nozzle to the turbine blade row. The guide vane 110, for example, may be configured, as a stationary vane or stator, and be included among plural similar guide vanes.

In the illustrated embodiment, the guide vane 110 is disposed within the pathway of the gas flow 102, with the gas flow 102 contacting and passing by the leading edge 112 of the guide vane 110 in the exhaust direction 104. The gas flow 102 then passes by the aft portion 130 of the guide vane 110 and on to the exhaust portion. Because the gas flow 102 from the combustor passing the leading edge 112 is at an elevated or high temperature as the gas flow 102 leaves the combustor, the guide vane 110, and especially the leading edge 112 exposed to direct contact with the gas flow 102, may become heated. For performance and/or durability reasons, it may be desirable to cool the leading edge 112 of the guide vane 110. In certain embodiments cooling air flow is directed toward the leading edge 112 from an interior portion of the guide vane 110 to help cool the leading edge 112. However, if the cooling air flow is obtained from ambient surroundings, the cooling air flow may include dust, sand, or other particulate matter. Further, the particulate matter, such as dust or sand, may tend to accumulate on heated surfaces with which the cooling air flow comes into contact. Thus, the particulate matter may tend to be deposited and accumulate, for example, on an interior surface of the leading edge 112, and/or may foul a film and/or holes of the leading edge 112. This may result in damage to the leading edge 112 (such as damage to a film and/or blockage of holes), reduction of the cooling efficiency of the leading edge 112, increased maintenance costs, shorter lifespan of the leading edge 112 and/or guide vane 110, or the like.

In the illustrated embodiment, the guide vane 110 defines an interior cavity 126. A guide tube 150 is disposed within the interior cavity 126 and is configured to provide a cooling air flow to the interior of the guide vane 110. In the illustrated embodiment, the guide tube 150 is formed having a main diameter 158 that tapers toward a first impingement opening 154. In the embodiment depicted in FIG. 1, the first impingement opening 154 is configured as an open slot or hole extending substantially along a length 156 of the guide tube 150. It should be noted that other arrangements, such as plural discrete openings positioned along all or a portion of the length 156 of the guide tube 150, may be employed in various embodiments. By way of example and not limitation, such openings may be formed as one or more of round holes, other shaped holes, slots, or the like. The first impingement opening 154 is configured opposite a first impingement feature 132.

As best seen in FIG. 2, the guide tube 150 includes an inlet 152 disposed toward the bottom (as depicted in FIG. 2) of the guide tube 150 that accepts a cooling flow 170. The cooling flow 170, for example, may be air drawn from ambient surroundings, and may be understood as a mix of air with particulate matter such as dust and/or sand. The cooling flow 170 is directed into and through the guide tube 150 in an inlet direction 180 (as depicted in FIG. 2) along the length 156 of the guide tube 150. As the cooling flow 170 proceeds in the inlet direction 180, the cooling flow is turned or re-directed in a first impingement direction 182 oriented from the guide tube 150 through the first impingement opening 154 toward the first impingement feature 132. In FIG. 2, the first impingement direction 182 is substantially perpendicular to the inlet direction 180. In other embodiments, the flow may be guided or re-directed to a first impingement direction that is angled with respect to the inlet direction but not substantially perpendicular. In the illustrated embodiment, the first impingement direction 182 is substantially aft (e.g., in the exhaust direction 104, or in the direction of the high temperature gas flow 102). As shown in FIG. 2, various portions 170a, 170b, 170c of the cooling flow 170 are re-directed in the first impingement direction 182.

In the illustrated embodiment, the cooling flow 170 is directed in the first impingement direction 182 and impinges upon the first impingement feature 132. The first impingement feature is configured to remove particulate from the cooling flow 170, with particulate from the cooling flow 170 accumulating in a collection area 134 proximate the first impingement feature 132 (see FIG. 3). In various embodiments, the first impingement feature 132 may be integral with or otherwise in thermal communication with the leading edge 112, or otherwise maintained at high enough temperature (albeit a temperature lower than the temperature of the leading edge 112 exposed to the high temperature gas flow 102) to improve or increase accumulation of particulate matter such as dust. Upon impingement of the cooling flow 170 with the first impingement feature 132, particulate matter is removed from the cooling flow 170 and accumulated proximate to the first impingement feature 132 (e.g., at a distance away from the leading edge 112), and the cooling flow 170 is redirected in a second (or cooling) impingement direction 184. Thus, after impingement with the first impingement feature 132, the cooling air flow 170 is turned or re-directed (e.g., by a surface of or otherwise associated with the first impingement feature 132) in the second impingement direction 184.

As best seen in FIG. 1, the cooling airflow 170 proceeds from the first impingement feature 132 toward the surface to be cooled (e.g., leading edge 112) along a second impingement direction 184. In some embodiments, the cooling flow 170 may be directed toward a cooling impingement insert such as a baffle 114 configured to provide impingement jets to cool the leading edge 112. The cooling flow 170 may be directed through a pathway defined by an exterior of the guide tube 150 and an interior wall or portion of the baffle 114 to a plenum 124. With reference to FIG. 2, cooling air may be directed from the plenum 124 through openings 120 of the baffle 114 as jets 190 which pass to and through holes 194 of the leading edge 112 and leave turbine component 110 as plural exit flows 192.

In the illustrated embodiment, as best seen in FIG. 1, the first impingement direction 182 is substantially aligned with (e.g. in same direction) the exhaust direction 104 and the second impingement direction 184 is substantially opposed to the exhaust direction 104. It may be noted that the second impingement direction 184 is depicted as generally toward the plenum 124 and leading edge 112, but the cooling flow 170 may be dispersed in multiple directions by a contour of the baffle 114 to a contoured surface of the leading edge 112 so that portions of the cooling flow are eventually directed in plural streams 192 in various directions shown in FIG. 1.

The embodiment depicted in FIG. 1 may provide for more efficient cooling of the leading edge 112 and/or improved lifetime of the guide vane 110, for example by reducing particulate buildup proximate the leading edge 112 as dust, sand, and/or other particulate matter is removed from the cooling air flow and accumulated proximate the first impingement feature 132 before adhering to a surface at the leading edge 112 where cooling is more beneficial. Accumulation of dust or other particulate proximate the aft portion 130 or first impingement feature 132 of the guide vane 110 may be of less concern or detriment than accumulation proximate the leading edge 112. For example, the aft portion 130 of the illustrated embodiment does not have holes to plug or a film to foul, and is not exposed to the same temperatures from the main gas path. It should be noted that various embodiments may be used in conjunction with other types of turbine members or components (e.g., shrouds, deflectors, or the like) configured for internal impingement cooling and/or in other portions (e.g., combustor, exhaust, trailing edge cavity of nozzle, or the like) of a turbine. The guide vane 110 depicted in FIG. 1 may be understood as being configured for two distinct impingements of a cooling air flow configured for different purposes. For example, the second impingement (e.g., with the leading edge 112) may be considered as a primary impingement, or cooling impingement. The first impingement (e.g., with the first impingement feature 132) occurs before the primary or cooling impingement and may be considered as a pre-impingement, and is configured to remove particulate from a cooling air flow before the cooling air flow impinges a surface to be cooled.

As indicated above, in the embodiment depicted in FIG. 1, the turbine component assembly 100 includes a guide vane 110 (which, as discussed herein, may be configured as a different turbine component such as a shroud or deflector), the guide tube 150, and the first impingement feature 132. The depicted guide vane 110 in turn includes a leading edge 112, an aft portion 130 disposed opposite the leading edge 112, and an impingement feature configured to facilitate impingement of the cooling air flow 170 with the leading edge 112. For example, the impingement feature may be configured as the baffle 114. The exterior of the leading edge 112 is contacted by the main gas path 102 and acts to direct the main gas path 102 through the nozzle and help achieve a desired pressure change in the nozzle. In some embodiments, the leading edge 112 may include holes 194 (see FIG. 2) that accept jets 190 to allow the cooling air flow 170 to pass through the leading edge 112. Alternatively or additionally, the exterior of the leading edge 112 may include a film configured to protect the leading edge 112 from the high temperature of the main gas path 102 that is supplied by the air passing through holes 194. Removal of particulate from the cooling air flow 170 at the first impingement feature 132 helps protects such holes, film, and/or other aspects of the leading edge 112 from particulate accumulation and corresponding damage and/or reduced component life.

As also indicated above, the guide vane 110 includes the interior cavity 126. The baffle 114 and the guide tube 150 are positioned within the cavity 126. The guide tube 150 and/or baffle 114 may be welded or brazed in place, for example to the metal cap 140. As seen in FIG. 1, the baffle 114 receives cooling air flow 170 in the second impingement direction 184 from the aft portion 130 of the guide vane 110. The cooling air flow 170 may be directed in the second impingement direction 184 to the plenum 124 for providing cooling air flow to the leading edge 112 through the baffle 114. In the illustrated embodiment, as best seen in FIG. 2, the baffle 114 includes openings 120 that provide jets 190 to an interior surface 113 of leading edge 112 to cool the leading edge 112. The baffle 114 is disposed a distance from leading edge 112 to form a gap 122. The baffle 114 may also include extensions 116. The extensions 116 in various embodiments may not have openings such as openings 120. In the illustrated embodiment, the extensions 116 join an interior surface of an aft-oriented location of the leading edge 112 or a portion of the guide vane 110 disposed aft of the leading edge 112 to form a seal 118 for the gap 122 to prevent air from the cooling flow 170 from contacting the interior surface 113 of the leading edge 112 without passing first through the baffle 114. The extensions 116, for example, may be tack welded to the interior of the guide vane 110 to form the seal 118.

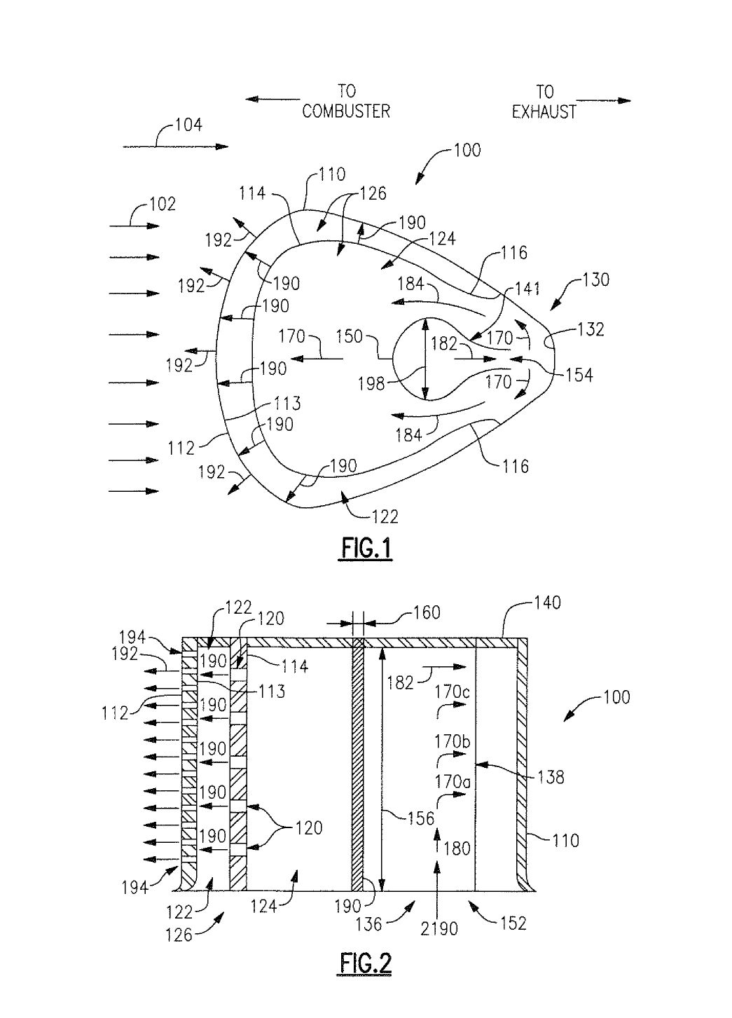

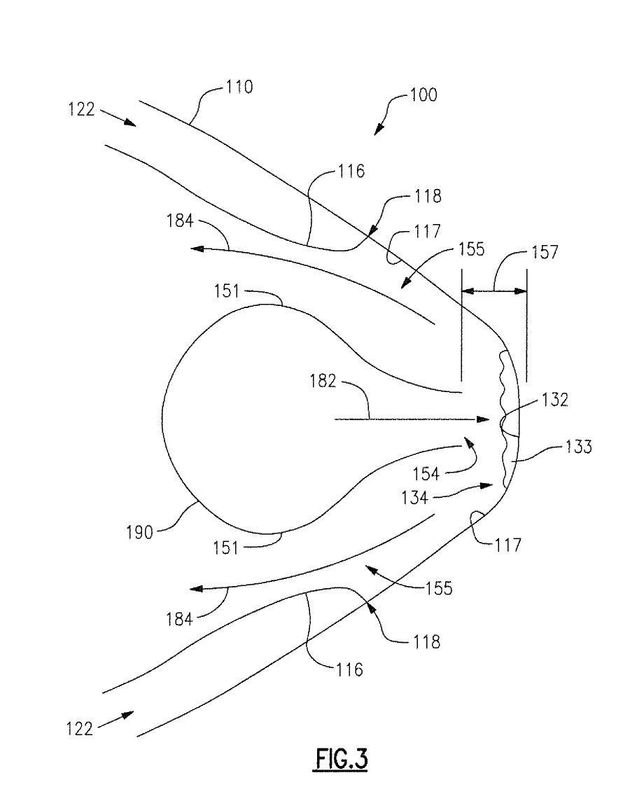

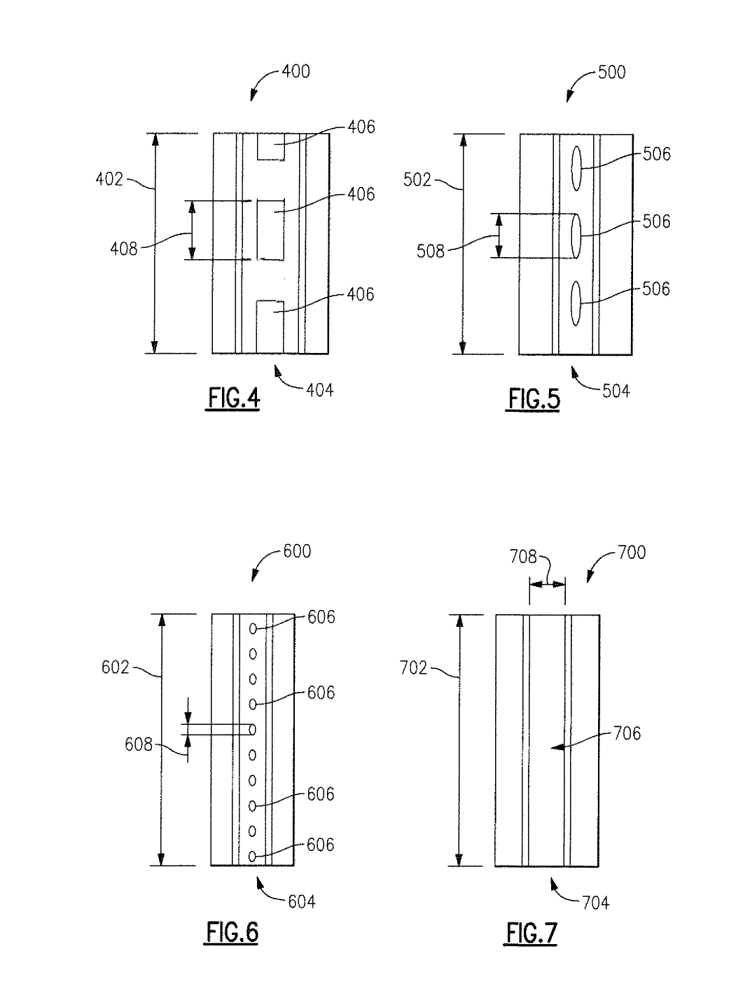

The guide tube 150, which in some embodiments may be made from the same or similar material as the baffle 114, includes an inlet 152 and a first impingement opening 154. In the illustrated embodiment, the first impingement opening 154 is configured as a continuous slot running substantially along the length 156 of the guide tube 152. However, other arrangements may be employed (see also FIGS. 4-7 for examples of alternate arrangements of first impingement openings). Generally, the internal geometry of the guide tube 150 (including the first impingement opening 154) is configured to direct cooling air up and through the guide tube 150 to the first impingement feature 132, and the outer geometry of the guide tube 150 includes contours configured to help guide flow from aft toward the leading edge 112 (e.g., to the plenum 124). The guide tube 150 may be welded or brazed in place, for example to a metal cap of the baffle 114 or guide vane 110 (e.g., metal cap 140).

As seen in FIG. 1, the guide tube 150 has a generally circular main portion that tapers toward the first impingement opening 154. The inner diameter 158 of the guide tube 150 may be, for example, selected from a range of between about 0.05 inches and about 1.0 inches. In various embodiments, other shapes or dimensions may be employed as appropriate. The guide tube 150 defines a taper 141 from the inner diameter 158 to the first impingement opening 154 that is configured to direct and/or accelerate the cooling flow 170 in the first impingement direction 182. In some embodiments, for example, the taper 141 may be a linear taper. As another example, in various embodiments the taper 141 may be a smooth curvilinear taper.

In the embodiment illustrated in FIGS. 1 and 2, the guide tube 150 includes an inlet portion 136 and an outlet portion 138. The outlet portion 138 (e.g., a width of the first impingement opening 154) in some embodiments may have a width that is selected from a range of between about 5 percent of the inner diameter 158 of the guide tube 150 and about 50 percent of the inner diameter 158 of the guide tube 150. For the embodiment depicted in FIG. 2, the inlet portion 136 is disposed along a bottom (in the sense of FIG. 2) portion or end of the guide tube 150, and the outlet portion 138 extends along a side of the guide tube 150 (e.g., a side disposed in an aft position relative to the gas flow 102). The guide tube 150 has a wall thickness 160 that may be, for example, selected from a range between about 0.010 inches and about 0.125 inches.

The first impingement feature 132 is configured to be impinged by the cooling air flow 170 traveling in the first impingement direction 182 from the first impingement opening 154. As the cooling air flow 170 impinges upon the first impingement opening 154, particulate matter from the cooling air flow 170 adheres to first impingement feature 132 as accumulation 133 (see FIG. 3), thereby removing particulate matter from the cooling air flow 170. The cooling flow 170 may then proceed (with particulate removed) along the second impingement direction 184 to the plenum 124 of the baffle 114 for distribution to impinge upon the interior surface 113 of the leading edge 112 to cool the leading edge 112. The first impingement feature 132 may be formed as a rib (e.g., a rib between a leading edge cavity and a trailing edge cavity of a guide vane), contoured surface, projection, or the like. In some embodiments, the first impingement feature 132 may be integral with the leading edge 112. For example, an internal rib may be formed from a portion of the internal wall of a guide vane that is aft of the leading edge 112.

In the illustrated embodiment, the first impingement feature 132 is disposed proximate the aft portion 130 of the guide vane 110. The first impingement feature 132 may be contoured or shaped to increase the capacity for fine particulate accumulation, but also to turn the cooling air flow 170 aerodynamically to minimize pressure loss of the cooling air flow 170 as the cooling air flow 170 proceeds to the plenum 124 of the baffle 114. The exterior of the guide tube 150, the interior of the guide vane 110 (e.g., the aft portion 130 of the guide vane), and the first impingement feature may be sized and positioned so that the provision of the cooling air flow 170 remains effective over a desired life span even as dust or other particulate accumulates proximate the first impingement feature 132. For example, the internal geometry of the tube guide assembly may be sized to accommodate a predetermined amount or thickness of particulate accumulation based on an expected accumulation rate and desired life time or maintenance cycle.

FIG. 3 is an enlarged view of the aft portion 130 of the guide tube assembly 100. As seen in FIG. 3, a collection area 134 for the accumulation 133 of particulate matter is disposed proximate the first impingement feature 132. As also seen in FIG. 3, the extensions 116 of the baffle 114 join an interior portion of guide vane 110 to seal the gap 122 from air that has not first passed through the baffle 114. The extensions 116 of the baffle 114 and/or interior surfaces 117 of the guide vane 110 may be configured to cooperate with an exterior surface 151 of the guide tube 150 to define a flow path 155 through which the cooling air is guided generally in the second impingement direction 184 to the plenum 124. In various embodiments, the width 157 of the flow path 155, for example, the distance 157 between the outer flow path wall and the impingement guide tube exit (e.g., first impingement opening 154), may be about the same as the width of the guide tube exit or greater. Again, the interior geometry of the turbine component assembly 100 may be designed to provide a flow path 155 that is “over-sized” to accommodate a given amount of particulate accumulation or build-up. In various embodiments, the interior geometry and/or interior surfaces of the turbine component assembly 100 are configured for accumulation of particulate matter.

FIGS. 4-7 depict various arrangements arrangement for a first impingement opening or openings. In FIGS. 4-6, discrete openings positioned along the length of a guide tube assembly are depicted. In various embodiments, a slot height or hole diameter for such discrete openings may be selected from a range between about 0.005 inches and about the diameter of the corresponding guide tube.

FIG. 4 depicts a guide tube assembly 400. The guide tube assembly 400 has a length 402, and a guide tube exit portion 404. The guide tube exit portion 404 includes plural slots 406 disposed along the length 402. In the illustrated embodiment, three slots 406 are shown, however, different numbers of slots 406 may be employed in various embodiments. The slots 406 are configured as first impingement openings to direct a cooling air flow in a first impingement direction (e.g., first impingement direction 182 discussed in connection with FIG. 1) to a first impingement feature (e.g., first impingement feature 132 discussed in connection with FIG. 1). The slots 406 may have a height 408 selected from a range between about 0.005 inches and about the diameter of the guide tube 400.

FIG. 5 depicts another exemplary guide tube assembly 500. The guide tube assembly 500 has a length 502, and includes a guide tube exit portion 504. The guide tube exit portion 504 includes plural oval openings 506 disposed along the length 502. In the illustrated embodiment, three oval openings 506 are shown, however, different numbers may be employed in various embodiments. The oval openings 506 are configured as first impingement openings to direct a cooling air flow in a first impingement direction (e.g., first impingement direction 182 discussed in connection with FIG. 1) to a first impingement feature (e.g., first impingement feature 132 discussed in connection with FIG. 1). The oval openings 506 may have a height 508 selected from a range between about 0.005 inches and about the diameter of the guide tube 500.

Similarly, FIG. 6 depicts a further exemplary guide tube assembly 600. The guide tube assembly 600 has a length 602, and includes a guide tube exit portion 604. The guide tube exit portion 604 includes plural circular openings 606 disposed along the length 602. In the illustrated embodiment, ten circular openings 606 are shown, however, different numbers may be employed in various embodiments. The circular openings 606 are configured as first impingement openings to direct a cooling air flow in a first impingement direction (e.g., first impingement direction 182 discussed in connection with FIG. 1) to a first impingement feature (e.g., first impingement feature 132 discussed in connection with FIG. 1). The circular openings 606 may have a diameter 608 selected from a range between about 0.005 inches and about the diameter of the guide tube 600.

FIG. 7 depicts yet another example of a guide tube assembly 700. The guide tube assembly 700 has a length 702, and includes a guide tube exit portion 704. The guide tube exit portion 704 includes a slot 706 that runs along the length 702. In the illustrated embodiment, similar to the embodiment depicted in FIGS. 1 and 2, the slot 706 extends along the entire length 702 of the guide tube assembly 700. In various embodiments, the slot 706 may extend only along a portion of the length 702. The slot 706 is configured as a first impingement opening to direct a cooling air flow in a first impingement direction (e.g., first impingement direction 182 discussed in connection with FIG. 1) to a first impingement feature (e.g., first impingement feature 132 discussed in connection with FIG. 1). The slot 706 may have a width 708 selected from a range between about 0.005 inches and about the diameter of the guide tube 700.

It should be noted that the above discussed embodiments of FIGS. 1-7 are provided by way of example and not limitation, as various components or aspects (including shapes, dimensions, or the like) of the above example embodiments may be modified, combined, added, removed, or re-arranged to form additional embodiments.

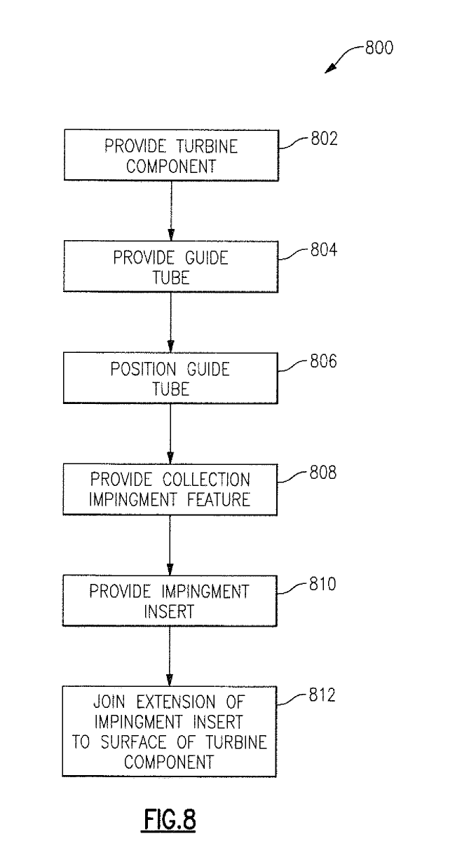

FIG. 8 is a flow chart of a method 800 for providing a guide tube assembly for directing a cooling air flow in a first impingement (or pre-impingement) direction configured to remove particulate matter from the cooling air flow in accordance with an embodiment. The method 800, for example, may employ structures or aspects of various embodiments discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

At 802, a turbine component is provided. The turbine component includes a surface to be cooled by internal impingement cooling (e.g., the leading edge 112 to be cooled by cooling air provided by the plenum 124). The turbine component, for example, may be configured as a vane, a shroud, a deflector, or the like. The turbine component defines an interior cavity, with the surface to be cooled disposed proximate a leading edge of the turbine component (relative to a flow of gas, such as gas from a combustor). The leading edge is configured to be contacted by and to direct a high temperature gas flow. In some embodiments, the turbine component may be an existing component or design to which a pre-impingement guide tube (e.g., guide tube 150) and/or a collection impingement feature (e.g., first impingement feature 132) are to be retro-fitted.

At 804, a guide tube (e.g., a pre-impingement guide tube such as guide tube 150) is provided. The guide tube has a length and includes an inlet disposed proximate to an end of the guide tube. The inlet is configured to accept the cooling air flow and to direct the cooling air flow along the length of the guide tube in the inlet direction. The at least one first impingement opening (e.g., slot, circular opening, oval opening, or the like) is configured to direct at least a portion of the cooling airflow along a first impingement direction toward a first impingement feature.

At 806, the guide tube is positioned. In the depicted embodiment, the guide tube is positioned so that the guide tube is disposed within the interior cavity of the turbine component with the at least one first impingement opening oriented toward an aft portion of the turbine component, so that the first impingement direction will be oriented toward a first impingement feature and particulate matter may be accumulated proximate the aft portion of the turbine component (or distanced from the leading edge or other surface to be cooled). In various embodiments, once positioned as desired, the guide tube may be brazed or welded to a top cap of the turbine component. In some embodiments, the guide tube may be positioned within an envelope defined by a baffle or other cooling impingement feature that is in turn positioned within an interior cavity of the turbine component. In certain embodiments, the guide tube is integrated with the turbine component. In various embodiments, all or a portion of the turbine component and/or guide tube may be formed using one or more of casting, additive manufacturing, or the like.

At 808, a collection impingement feature (e.g., the first impingement feature 132) is provided. The collection impingement feature may be disposed opposite the at least one first impingement opening along the first impingement direction and positioned to receive the at least a portion of the cooling airflow directed in the first impingement direction. In the depicted embodiment, the collection impingement feature is configured to collect particulate matter from the cooling airflow as the cooling air flow impinges the collection impingement feature. Also, the collection impingement feature is configured to direct the at least a portion of the cooling air flow in a second impingement direction toward the surface of the turbine component to be cooled (e.g, via a plenum such as the plenum 124). In various embodiments, the collection impingement feature may be integral with the turbine component provided at 802, for example as a portion of an interior wall of an aft portion of the turbine component. The collection impingement feature may be formed by one or more of casting, molding, machining, welding, or the like.

At 810, an impingement insert (e.g., baffle 114) is provided. The impingement insert is disposed within the interior cavity a desired distance from the surface to be cooled, thus defining a gap between the impingement insert and the surface to be cooled. The impingement insert in various embodiments may be configured to cooperate with an exterior surface of the guide tube to define a flow path configured to direct the cooling air flow from the collection impingement feature toward the surface to be cooled, for example to a plenum of the impingement insert from which the cooling air will be distributed to the surface to be cooled. In various embodiments, an existing impingement insert such as a baffle of a turbine component may be employed with relatively minor geometric modification to accommodate the use of a pre-impingement guide tube (e.g., the guide tube 150).

At 812, an extension of the impingement insert is joined to a surface of the turbine component. The joining may be accomplished, for example, by tack welding. In the depicted embodiment, the extension is joined to an interior surface of the turbine component to seal the gap between the surface to be cooled and the impingement insert from air flow that has not passed through the impingement insert.

FIG. 9 provides a cross-sectional view of a guide vane 900 formed in accordance with an embodiment and FIG. 10 provides a perspective view of the guide vane 900. The guide vane 900 is positioned to receive a flow 902 that initially contacts a leading edge 910. The guide vane 902 is configured as an airfoil and includes a pressure side 904 and a suction side 906. The guide vane 902 also includes a leading edge cavity 920 and a trailing edge cavity 930 separated by a rib 940. First impingement features (e.g., the first impingement feature 132) for one or both of the leading edge cavity 920 or the trailing edge cavity 930 may be formed on a surface of the rib 940 oriented toward the interior of the corresponding cavity. In FIG. 9, the guide vane 900 includes a leading edge impingement insert 922 and a leading edge guide tube 924, and also includes a trailing edge impingement insert 932 and a trailing edge guide tube 934. (The impingement inserts 922, 932 and guide tubes 924, 934 are omitted from FIG. 10 for clarity).

As shown in FIG. 10, one or both of the leading edge cavity 920 or the trailing edge cavity 930 may receive a cooling flow. In the embodiment depicted in FIG. 10, the leading edge cooling flow 950 and the trailing edge cooling flow 960 are provided in opposite directions. Once within the respective guide tubes (see FIG. 9) the corresponding cooling flows may be directed by the guide tubes to first impingement features for the removal of particulate from the cooling flow, and from there to surfaces to be cooled, similar to the discussion herein, for example, in connection with FIGS. 1-3.

Thus, various embodiments provide for the prevention, minimization, or reduction of fine particulate deposition proximate to surfaces to be cooled by an impinging cooling air flow (e.g., impingement jets within a turbine guide vane). For example, an inlet tube or pre-impingement sleeve may be employed to deposit fine particulate matter onto a collection feature, such as an internal rib of an aft portion of a turbine guide vane, prior to the delivery of the cooling air to an impingement baffle and/or to a surface to be cooled. By depositing particulate matter on the internal rib or other feature, the amount of particulate in the cooling air flow prior to the desired cooling impingement is reduced, and the accumulation rate of particulate, for example, in or proximate to impingement jets, is reduced.

Various embodiments of systems and methods are described and illustrated herein with respect to being used in conjunction with a guide vane for a nozzle of a gas turbine engine. It may be noted that various embodiments may be used in connection with other turbine components configured for receiving a cooling air flow drawn from ambient surroundings (e.g., splash plates, deflectors, shrouds, other blades or vanes, or the like).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A guide tube assembly for impingement cooling of a turbine component, the guide tube assembly comprising:
a guide tube having a length, the guide tube comprising:
an inlet disposed proximate to an end of the guide tube, the inlet configured to accept a cooling air flow and to direct the cooling air flow along the length of the guide tube in an inlet direction; and
at least one first impingement opening configured to direct at least a portion of the cooling air flow along a first impingement direction; and
a collection impingement feature disposed opposite the at least one first impingement opening along the first impingement direction and positioned to receive the at least a portion of the cooling airflow directed in the first impingement direction, the collection impingement feature configured to collect particulate matter from the cooling airflow upon impingement of the cooling airflow with the collection impingement feature, the collection impingement feature further configured to direct the at least a portion of the cooling air flow in a second impingement direction toward a surface of the turbine component to be cooled by the cooling air flow.

2. The guide tube assembly of claim 1, wherein the collection impingement feature is formed as an integral portion of the turbine component.

3. The guide tube assembly of claim 1, wherein the collection impingement feature is contoured to reduce pressure loss as the at least a portion of the cooling air flow encounters the collection impingement feature.

4. The guide tube assembly of claim 1, wherein the first impingement direction is substantially perpendicular to the inlet direction.

5. The guide tube assembly of claim 1, wherein the at least one first impingement opening comprises a slot extending substantially along the length of the guide tube.

6. The guide tube assembly of claim 1, wherein the at least one first impingement opening comprises plural discrete openings disposed along the length of the guide tube.

7. The guide tube assembly of claim 1, wherein the guide tube is configured to taper toward the at least one first impingement opening to at least one of accelerate or direct the at least a portion of the cooling airflow toward the collection impingement feature.

8. An assembly comprising:
a turbine component comprising a surface to be cooled, the turbine component defining an interior cavity;
a guide tube disposed within the interior cavity of the turbine component, the guide tube having a length, the guide tube comprising:
an inlet disposed proximate to an end of the guide tube, the inlet configured to accept a cooling air flow and to direct the cooling air flow along the length of the guide tube in an inlet direction; and
at least one first impingement opening configured to direct at least a portion of the cooling air flow along a first impingement direction; and
a collection impingement feature disposed opposite the at least one first impingement opening along the first impingement direction and positioned to receive the at least a portion of the cooling airflow directed in the first impingement direction, the collection impingement feature configured to collect particulate matter from the cooling airflow upon impingement of the cooling airflow with the collection impingement feature, the collection impingement feature further configured to direct the at least a portion of the cooling air flow in a second impingement direction toward the surface of the turbine component to be cooled.

9. The assembly of claim 8 further comprising an impingement baffle spaced a distance from the surface to be cooled, the impingement baffle configured to receive the cooling air flow in the second impingement direction and direct the cooling air flow in the second impingement direction as plural jets toward the surface to be cooled.

10. The assembly of claim 8 further comprising an impingement baffle spaced a distance from the surface to be cooled whereby a gap is defined between the impingement baffle and the surface to be cooled, the impingement baffle configured to cooperate with an exterior surface of the guide tube to define a flow path configured to direct the cooling air flow from the collection impingement feature toward a plenum of the impingement baffle.

11. The assembly of claim 10, wherein the impingement baffle comprises an extension joined to a surface of the turbine component configured to seal the gap from air flow that has not passed through the impingement baffle.

12. The assembly of claim 8, wherein the surface to be cooled is configured as a leading edge configured to be contacted by and to direct a high temperature gas flow from a combustor in an exhaust direction, wherein the first impingement direction is directed substantially away from the leading edge, and wherein the collection impingement feature is disposed proximate an aft portion of the turbine component.

13. The assembly of claim 8, wherein the collection impingement feature is formed as an integral portion of the turbine component.

14. The assembly of claim 8, wherein the collection impingement feature is contoured to reduce pressure loss as the at least a portion of the cooling air flow is turned proximate the collection impingement feature.

15. The assembly of claim 8, wherein the first impingement direction is substantially perpendicular to the inlet direction.

16. The assembly of claim 8, wherein the guide tube is configured to taper toward the at least one first impingement opening to at least one of accelerate or direct the at least a portion of the cooling airflow toward the collection impingement feature.

17. A method of providing a guide tube assembly for directing a cooling air flow in a first impingement direction configured to remove particulate matter from the cooling air flow, the method comprising:
providing a turbine component comprising a surface to be cooled, the turbine component defining an interior cavity, the surface to be cooled disposed proximate a leading edge of the turbine component, the leading edge configured to direct a high temperature gas flow passing by the leading edge;
providing a guide tube, the guide tube having a length, the guide tube comprising:
an inlet disposed proximate to an end of the guide tube, the inlet configured to accept the cooling air flow and to direct the cooling air flow along the length of the guide tube in an inlet direction; and
at least one first impingement opening configured to direct at least a portion of the cooling air flow along the first impingement direction;
positioning the guide tube disposed within the interior cavity of the turbine component with the at least one first impingement opening oriented toward an aft portion of the turbine component; and
providing a collection impingement feature disposed opposite the at least one first impingement opening along the first impingement direction and positioned to receive the at least a portion of the cooling airflow directed in the first impingement direction, the collection impingement feature configured to collect particulate matter from the cooling airflow upon impingement of the cooling airflow with the collection impingement feature, the collection impingement feature further configured to direct the at least a portion of the cooling air flow in a second impingement direction toward the surface of the turbine component to be cooled.

18. The method of claim 17 further comprising providing an impingement baffle spaced a distance from the surface to be cooled whereby a gap is defined between the impingement baffle and the surface to be cooled, the impingement baffle configured to cooperate with an exterior surface of the guide tube to define a flow path configured to direct the cooling air flow from the collection impingement feature toward a plenum of the impingement baffle.

19. The method of claim 18, wherein the impingement baffle comprises an extension, the method further comprising joining the extension to a surface of the turbine component to seal the gap from air flow that has not passed through the impingement baffle.

20. The method of claim 17, wherein the collection impingement feature is formed as an integral portion of the turbine component.
